(19) United States
(12) Patent Application Publication
(10) Pub. No.: US 2014/0341016 A1
(43) Pub. Date: Nov. 20, 2014

(54) METHOD AND APPARATUS FOR ENABLING EFFICIENT RESOURCE ALLOCATION

(71) Applicant: Telefonaktiebolaget L M Ericsson (PUBL), Stockholm (SE)

(72) Inventor: Sriganesh Kini, Fremont, CA (US)

(73) Assignee: Telefonaktiebolaget L M Ericsson (PUBL), Stockholm (SE)

(21) Appl. No.: 14/029,288

(22) Filed: Sep. 17, 2013

Related U.S. Application Data
(60) Provisional application No. 61/823,144, filed on May 14, 2013.

(51) Int. Cl. H04L 12/917

(52) U.S. Cl. CPC H04L 47/76
USPC 370/230

(57) ABSTRACT

Embodiments of the present disclosure include a method and intermediate label switch router (LSR) for enabling efficient resource allocation for point to multi-point signaling. In one embodiment, upstream traffic specification information associated with a plurality of spoke nodes is received. The upstream traffic specification information is sent to a hub. Upstream flow specification information is received from the hub. The upstream flow specification information is used to allocate resources among the plurality of spoke nodes proportionally or in accordance with a resource sharing mode.

A method and hub for enabling efficient resource allocation for point to multi-point signaling is also disclosed. In one embodiment, upstream traffic specification information is received from an intermediate label switch router. The upstream traffic specification information can be an upstream traffic specification list. The upstream traffic specification list is used to generate an upstream flow specification for each respective sub label switch path (sub-LSP).

### CROSS-REFERENCES TO RELATED APPLICATIONS

This application claims priority to U.S. Provisional Application Ser. No. 61/823,144, filed on May 14, 2013, the entire disclosure of which is hereby incorporated herein by reference in its entirety.

### FIELD

The present disclosure relates to point-to-multi-point (P2MP) bi-directional label switched path (LSP), e.g., Hub and Spoke Multipoint LSP (HSMP LSP) signaling. More particularly, the present disclosure relates to protocol extensions for P2MP that enable highly efficient resource allocation.

### BACKGROUND

There are applications that require bi-directional, co-routed and guaranteed communication from a root node to several leaf nodes in a hub and spoke fashion. To meet such application requirements in a Multi-protocol Label Switching (MPLS) network a Hub and Spoke Multipoint Traffic Engineered Label Switched Path (HSMP TE LSP) with resource reservations for guaranteed communication has been defined. A protocol to setup such LSPs by re-using and extending P2MP reservation protocol traffic engineering (RSVP-TE) has also been defined.

There are many applications that require one-to-many bi-directional communication. Making such applications work over a MPLS network by using both P2MP and point-to-point (P2P) constructs results in scalability issues. A technique has been defined to do one-to-many bidirectional communication over an MPLS network that re-uses the existing P2MP and P2P constructs in MPLS but combines them in a scalable manner. This technique re-uses and extends the current traffic-engineered P2MP and P2P constructs and protocols.

Two representative applications are described that require one-to-many bi-directional communication. The first is a ‘Time Synchronization’ application. The second is a P2MP pseudowire (PW) application.

With time Synchronization, i.e., over an MPLS network, a scalable time-sync architecture requires the master to provide time synchronization to a large number of slaves. It requires the P2P messages to flow bi-directionally between master and slave in a hub and spoke manner. More importantly these messages must have the same delay in both directions. This requires the underlying network to reserve resources to transport P2P messages and also to co-route them in both directions to avoid any differences in the delays of the paths in both directions.

A P2MP PW is required for the virtual private multicast service (VPMS) service. In this application the root provider edge (PE) router requires bi-directional communication with several leaf PEs. The underlying MPLS transport should support this type of communication for the P2MP PW in a reliable and efficient manner.

A straightforward method to achieve one-to-many bi-directional communication with resource guarantees is to use a P2MP RSVP-TE tunnel from the hub PE to the spoke PEs and use P2P RSVP-TE tunnels from each spoke PE to the hub PE. The spoke-to-hub P2P tunnels can be explicitly routed such that they are co-routed along the reverse direction of the P2MP tunnel. In this model, scalability issues arise both in the data plane and the control plane.

An application with a hub and spoke bi-directional communication over a tree topology MPLS network is illustrated in FIG. 1. The hub label switch router (LSR) is A and the spoke LSRs are E, F, G, and H. For communication from the hub to the spokes, a P2MP LSP can be setup with A as the root and E, F, G and H as leaves. For communication from the spokes to the hub, a P2P LSP can be setup from each spoke to the hub.

Each LSR along this tree will have to allocate a unique label for each of the P2P LSPs that go from spoke to hub through it. This leads to a linear increase in forwarding state at each LSR in proportion to the number of spoke nodes that are in its sub-tree. This has poor scaling characteristics in the data plane as the number of spoke nodes increase.

Each LSR also has to allocate a control plane state for each of the P2P LSPs that go from spoke to hub through the respective LSR. Each P2P LSP will need a separate path state block (PSB) and a reservation state block (RSB) and these will store additional information on signaling attributes. This state is in addition to the state maintained for the P2MP LSP. Clearly this state increases linearly with the number of spoke nodes that are in its sub-tree. This approach exhibits poor scaling characteristics in the control plane as the number of spoke nodes increase. Also the number of signaling messages increases linearly though some of it may be mitigated by using refresh reduction.

A hub and spoke traffic-engineered multipoint LSP (HSMP TE LSP) is defined to solve the above issues with resource reservations. Such an LSP is a combination of an explicitly routed uni-directional traffic-engineered P2MP LSP from the hub to the spokes and a co-routed uni-directional MP2P LSP from the spokes to the hub. HSMP TE LSP operates on a data plane and a control plane.

In the direction from hub-to-spoke the data plane processing is the same as that of a P2MP LSP. In the direction from the spokes to the hub, each LSR allocates labels for its upstream LSRs. Each LSR merges the traffic received from multiple upstream LSRs before forwarding it on the LSP towards the hub. It should be noted that due to label merging the generic alert label (GAL) processing in the direction from spoke to hub is not defined.

The signaling protocol to setup a HSMP TE LSP can re-use the signaling protocol for P2MP RSVP-TE (RFC4875) with some extensions. The hub and spokes of a HSMP LSP can be modeled the same as the source and leaves, respectively, of a P2MP LSP. A source-to-leaf (S2L) sub-LSP defined in RFC4875 for the P2MP LSP is used to represent a hub-to-spoke communication of the HSMP LSP. The bidirectional co-routed nature of the communication from the hub to the spoke must be signaled using the extensions defined in section 3 of RFC3473. Each Path message of a HSMP LSP LSR must have a Upstream_Label object. If a PathErr is received in response with a “Routing problem/Unacceptable label value” indication then the Acceptable Label Set (if present) must be examined to allocate a label for the Upstream_Label object. If an LSR signaling an HSMP LSP receives PathErr messages with different Acceptable Label Sets from different neighboring LSRs then the LSR may need to allocate more than one label to satisfy all the Acceptable Label Sets. The LSR should try to minimize the number of unique labels allocated for a HSMP LSP in such a case.

Pruning and grafting for a HSMP LSP follow the same procedures as for a P2MP LSP. During re-merge in addition to the procedures in section 18.1.1 of RFC4875, the ingress or transit LSR that creates the branch would also be a re-merge LSR for the traffic from the spokes towards the hub. Also the re-merge node for the traffic from hub to spoke would be a branching node for traffic from the spokes to the hub. The LSR that is branching the traffic from the spokes to the hub would duplicate the traffic whereas the LSR that is re-merging the traffic should forward traffic only from one the incoming interfaces.

The HSMP LSP also requires bandwidth allocation that is asymmetric between the hub-to-spoke and the spoke-to-hub direction. At the same time it requires the spokes to be able to request different amounts of bandwidth towards the hub. The protocol extensions defined in RFC6387 are used for asymmetric bandwidth allocation between the hub-to-spoke and spoke-to-hub directions. Upstream traffic specification (UPSTREAM_TSPEC), upstream advertisement specification (UPSTREAM_ADSPEC) and upstream flow specification (UPSTREAM_FLOWSPEC) objects are also used in a HSMP LSP. An adspec is an object in a path message that carries a package of one pass with advertising (OPWA) information. However in case of a HSMP LSP an intermediate LSR can receive different UPSTREAM_TSPECs in the reservation request (Resv) messages from neighboring LSRs.

Some applications require a hub and spoke style bi-directional communication with resource reservation. Example applications are time synchronization and P2MP pseudowire. The spoke to hub direction of communication is a multipoint-to-point communication pattern and existing protocols such as RSVP-TE (RFC3209) or P2MP RSVP-TE (RFC4875) do not support resource reservation for such cases. One method to support resource reservation is combining the RFC4875 procedures with RFC6387. However the limitations of the RFC4875 specifications lead to a highly inefficient resource reservation. Combining RFC4875 and RFC6387 so that the bandwidth is efficiently allocated is not defined in the current standard specifications.

Therefore, there is a need in the art to solve the above described problems and perform resource reservations in a highly efficient yet scalable manner for the spoke to hub direction of a hub and spoke multipoint LSP.

### SUMMARY

Disclosed is a method and intermediate label switch router (LSR) for enabling efficient resource allocation for point to multi-point signaling. In one embodiment, upstream traffic specification information associated with a plurality of spoke nodes is received. The upstream traffic specification information is sent to a hub. Upstream flow specification information is received from the hub. The upstream flow specification information is used to allocate resources among the plurality of spoke nodes proportionally or in accordance with a resource sharing mode.

The upstream traffic specification information is combined from the plurality of spoke nodes. Combining upstream traffic specification information can be accomplished by determining a sum of upstream traffic specifications from the plurality of spoke nodes.

In one embodiment, the upstream flow specification information is received in a path message from the hub. The intermediate LSR can generate an upstream flow specification using a proportional flow specification operation. The generated upstream flow specification can be calculated as a fraction of the received upstream flow specification.

In one embodiment, the traffic specification information for each spoke node is propagated to the hub. The traffic specification information for each node can be propagated to the hub using an upstream traffic specification list generated by the intermediate LSR. The upstream traffic specification list can be sent to the hub using an upstream sender template.

A method and hub for enabling efficient resource allocation for point to multi-point signaling is disclosed. In one embodiment, upstream traffic specification information is received from an intermediate label switch router. The upstream traffic specification information can be an upstream traffic specification list. The upstream traffic specification list is used to generate an upstream flow specification for each respective sub label switch path (sub-LSP). In one embodiment, a format of the sub-LSP is modified by appending a sub-LSP flow specification.

### BRIEF DESCRIPTION OF THE DRAWINGS

The present invention is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one. Further, when a particular feature, structure, or characteristic is described in connection with an embodiment, it is submitted that it is within the knowledge of one skilled in the art to affect such feature, structure, or characteristic in connection with other embodiments whether or not explicitly described.

FIG. 1 is an illustration of tree topology for a multi-protocol label switching network.

FIG. 2 is an illustration of a hub and spoke system according to one embodiment.

FIG. 3 is an illustration of a system diagram of a message flow according to one embodiment.

FIG. 4 is an illustration of a system diagram of a message flow according to one embodiment.

FIG. 5 is a block diagram of a method for enabling efficient resource allocation for point to multi-point signaling using an intermediate label switch router according to one embodiment.

FIG. 6 is a block diagram of a method for enabling efficient resource allocation for point to multi-point signaling using a hub according to one embodiment.

FIG. 7 is an illustration of an example network node or element according to one embodiment.

### DESCRIPTION OF EMBODIMENTS

In the following description, numerous specific details are set forth. However, it is understood that embodiments of the invention may be practiced without these specific details. In other instances, well-known circuits, structures and techniques have not been shown in detail in order not to obscure the understanding of this description. It will be appreciated, however, by one skilled in the art that the invention may be practiced without such specific details. Those of ordinary skill in the art, with the included descriptions, will be able to implement appropriate functionality without undue experimentation.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

As used herein, a network element (e.g., a router, switch, bridge) is a piece of networking equipment, including hardware and software that communicatively interconnects other equipment on the network (e.g., other network elements, end stations). Some network elements are “multiple services network elements” that provide support for multiple networking functions (e.g., routing, bridging, switching, Layer 2 aggregation, session border control, Quality of Service, and/or subscriber management), and/or provide support for multiple application services (e.g., data, voice, and video). Subscriber end stations (e.g., servers, workstations, laptops, netbooks, palm tops, mobile phones, smartphones, multimedia phones, Voice Over Internet Protocol (VOIP) phones, user equipment, terminals, portable media players, tablets, GPS units, gaming systems, set-top boxes) access content/services provided over the Internet and/or content/services provided on virtual private networks (VPNs) overlaid on (e.g., tunneled through) the Internet. The content and/or services are typically provided by one or more end stations (e.g., server end stations) belonging to a service or content provider or end stations participating in a peer to peer service, and may include, for example, public webpages (e.g., free content, store fronts, search services), private webpages (e.g., username/password accessed webpages providing email services), and/or corporate networks over VPNs. Typically, subscriber end stations are coupled (e.g., through customer premise equipment coupled to an access network (wired or wirelessly)) to edge network elements, which are coupled (e.g., through one or more core network elements) to other edge network elements, which are coupled to other end stations (e.g., server end stations).

Different embodiments of the invention may be implemented using different combinations of software, firmware, and/or hardware. Thus, the techniques shown in the figures can be implemented using code and data stored and executed on one or more electronic devices (e.g., an end station, a network element). Such electronic devices store and communicate (internally and/or with other electronic devices over a network) code and data using computer-readable media, such as non-transitory computer-readable storage media (e.g., magnetic disks; optical disks; random access memory; read only memory; flash memory devices; phase-change memory) and transitory computer-readable transmission media (e.g., electrical, optical, acoustical or other form of propagated signals—such as carrier waves, infrared signals, digital signals). In addition, such electronic devices typically include a set of one or more processors coupled to one or more other components, such as one or more storage devices (non-transitory machine-readable storage media), user input/output devices (e.g., a keyboard, a touchscreen, and/or a display), and network connections. The coupling of the set of processors and other components is typically through one or more busses and bridges (also termed as bus controllers). Thus, the storage device of a given electronic device typically stores code and/or data for execution on the set of one or more processors of that electronic device.

Presently disclosed are procedures including protocol extensions for the signaling protocol (P2MP RSVP-TE) that enable a highly efficient resource allocation. Disclosed are two approaches or methods for achieving this highly efficient resource allocation.

The proportional method (P-method) makes no change to the signaling protocol packet format. As such, the P-method is more backward compatible. The downside is that this method does not give the hub LSR fine-grained control over the resource allocations to each spoke LSR.

The granular method (G-method) allows the hub LSR fine-grained control over the resource allocation to each spoke LSR. In order to implement the G-method, protocol changes are needed. Hence, this method is not as backward compatible as the P-method.

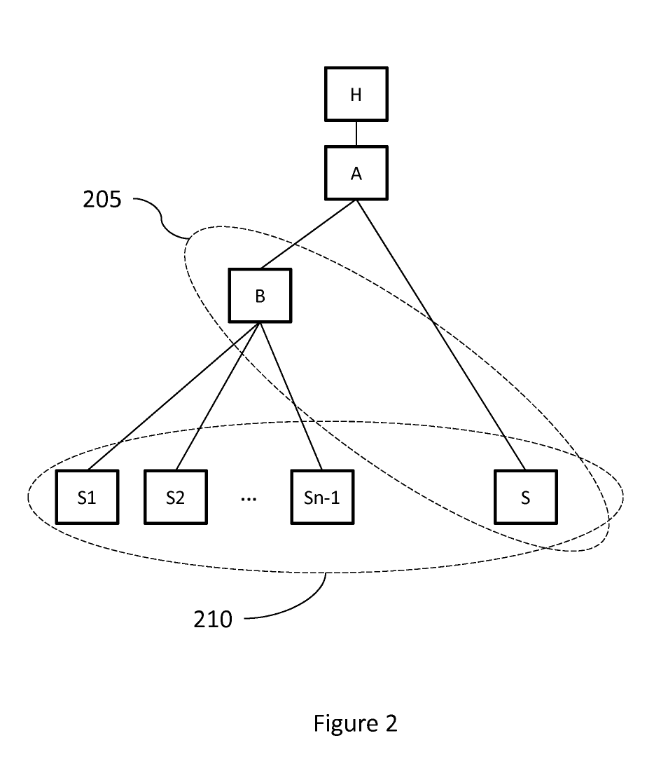

FIG. 2 illustrates a hub and spoke system. Hub, H, is coupled to intermediate node, A, which is coupled to upstream node, B, and spoke, S. Upstream node, B, is also coupled to spokes, S1, S2, . . . , Sn-1. Spokes (S1, S2, . . . , Sn-1, S) can also be referred to as spoke nodes or leaf nodes 310. Efficient resource allocation is accomplished by factoring in traffic specifications received from each directly coupled node 305, e.g., the plurality of traffic specifications received from upstream node B and the traffic specification received from spoke S.

The reservation style defined in RFC2205 applies to two different LSPs of the same LSP tunnel. In one embodiment, the present disclosure defines a reservation style between different S2L sub LSPs of a HSMP LSP. This reservation style applies to the reservation for the traffic direction from spoke to hub (in other words from leaf to source). This reservation style is henceforth referred to as L2S Style.

The L2S Style is signaled in P2MP RSVP-TE using encoding similar to the STYLE object defined in section A.7 of RFC2205 and is denoted as the L2S_STYLE object. Section A.7 discloses the following style class: STYLE class=8. In accordance with the present disclosure, a new class number is allocated to identify the L2S_STYLE object.

The L2S_STYLE is included in the Path, PathTear, PathErr and Notify messages. The L2S_STYLE immediately follows the UPSTREAM_FLOWSPEC object in the message encodings.

The L2S Style is used by the intermediate LSRs to apply ingress and egress QoS policies in the leaf to source direction of traffic, i.e., traffic from spoke to hub. When the L2S Style is SE (Shared Explicit), the egress policer (i.e., egress in the Leaf to Source direction) is derived from the max value of all the UPSTREAM_FLOWSPECs of each S2L LSP. When the L2S Style is FF (Fixed Filter), the egress policer is derived from the sum of the values of UPSTREAM_FLOWSPECs of each S2L LSP.

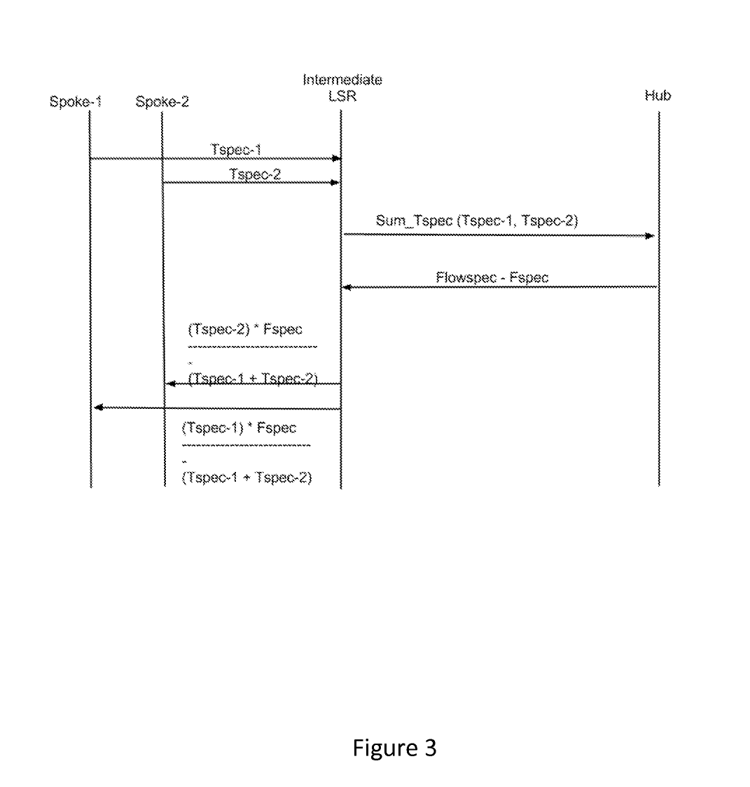

FIG. 3 illustrates a system diagram of a message flow according to one embodiment. In the P-method, each spoke sends an UPSTREAM_TSPEC as defined in RFC 6387 in the Resv message. When the application requires separate flow reservation from each spoke to the hub, the Fixed Filter (FF) style reservation is used. As defined in RFC 6387, the format of an UPSTREAM_TSPEC object is the same as a SENDER_TSPEC object, which includes the definition of class types and their formats. The intermediate LSRs combine UPSTREAM_TSPECs received from the upstream LSRs using the Sum Tspec operation referred to in RFC2205. In this case, the Sum Tspec operation is a calculation of the sum of all Tspecs supplied by spokes directly upstream, i.e., from the spoke to hub direction, to the intermediate LSR. Note that the LSR maintains state within each Resv State Block (RSB) about the Tspec sent by the upstream LSR. The hub generates an UPSTREAM_FLOWSPEC to be sent in the Path message. Using the received UPSTREAM_FLOWSPEC, each intermediate LSR generates an upstream flow specification to be sent to the upstream LSR using the following operation called “proportional flowspec”. This operation is described as follows. In one embodiment, there are n upstream LSRs sending upstream traffic specifications denoted as UTspec-1, UTspec-2, . . . , UTspec-n. The intermediate LSR generates an UPSTREAM_FLOWSPEC in proportion to the Tspec received from the upstream LSRs and directly coupled spokes. In other words, for an upstream LSR i the Flowspec is calculated as a fraction (UTspec-i/Sum_Tspec(1, . . . n)) of the received UPSTREAM_FLOWSPEC.

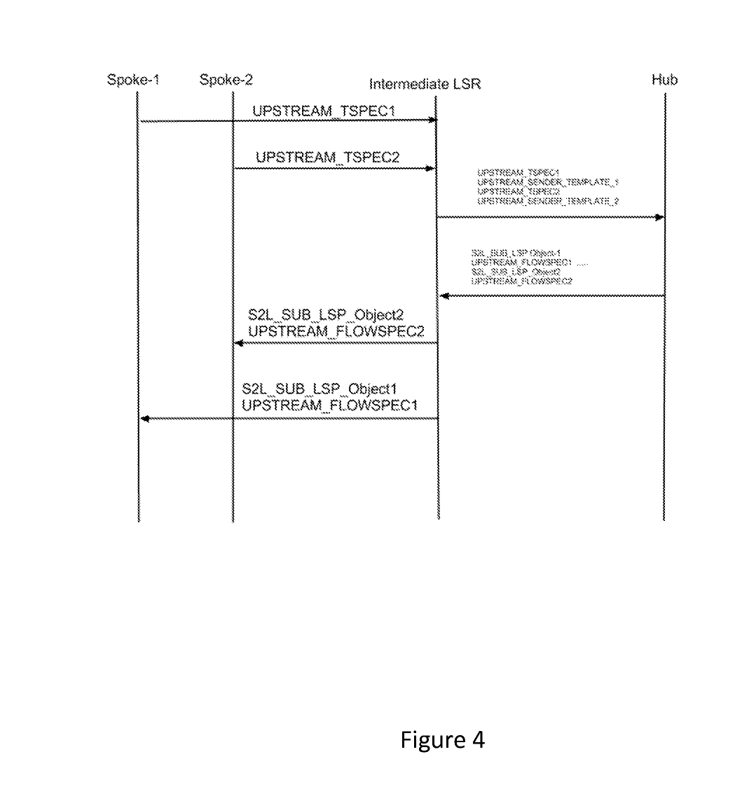

FIG. 4 illustrates a system diagram of a message flow according to one embodiment. In the G-method, each spoke generates an UPSTREAM_TSPEC as defined in RFC 6387 in the Resv message. The intermediate LSR does not combine the Tspecs, but rather propagates the information about the Tspec requested by each spoke, e.g., spoke node or leaf node, all the way to the hub. This information can be conveyed by modifying the packet formats already defined in RFC 4875 and RFC 6387. There are several ways to modify the packet format. In one embodiment, instead of the UPSTREAM_TSPEC defined in RFC6387, a new modified object UPSTREAM_TSPEC_list is used and is defined as follows. Its encoding is:

UPSTREAM_TSPEC_list::==UPSTREAM_TSPEC
UPSTREAM_SENDER_TEMPLATE [ UPSTREAM_TSPEC_list ]

The UPSTREAM_SENDER_TEMPLATE is similar to the SENDER_TEMPLATE that is defined in RFC 3209. However, in this case, the IP address in the UPSTREAM_SENDER_TEMPLATE is the address of the respective spoke. When the hub processes the UPSTREAM_TSPEC_list, the hub generates an appropriate UPSTREAM_FLOWSPEC for that S2L sub-LSP, e.g., the path from the hub to a respective spoke node or leaf node, and signals the S2L sub-LSP, e.g., using one or more Path messages. As described in RFC 4875, one or more path messages can be used to signal one or more S2L sub-LSPs. To signal an UPSTREAM_FLOWSPEC per S2L sub LSP, there are several ways to encode the information. In one embodiment, the format of the S2L_SUB_LSP is modified by appending an S2L_SUB_LSP_FLOWSPEC object to it. The format of the S2L_SUB_LSP_FLOWSPEC is the same as the FLOWSPEC object defined in RFC 2205. An intermediate LSR processes the object as it would process a normal FLOWSPEC object except that it now takes into account the resource sharing mode (i.e. fixed filter (FF), shared explicit (SE), etc.) and allocates resources accordingly. Note that in one embodiment, mixed mode allocations are not allowed unless multiple classes of receivers are contemplated. A main advantage of this method is that the hub can apply spoke-specific policies for that HSMP LSP by allocating resources depending on the identity of a specific spoke, instead of each spoke getting a proportion of the bandwidth as described in the P-method. This method, however, is more complex to implement.

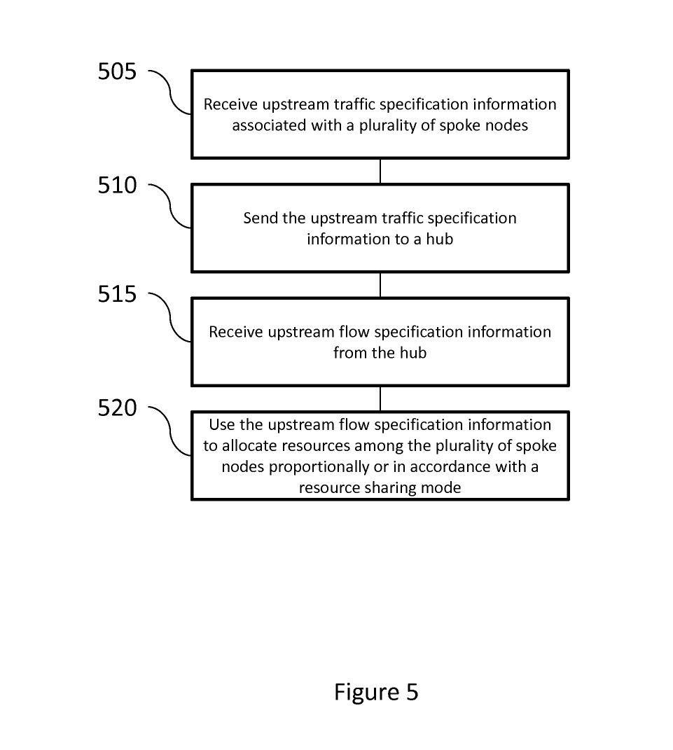

FIG. 5 illustrates a diagram of a method for enabling efficient resource allocation for point to multi-point signaling using an intermediate label switch router (LSR) according to one embodiment. At block 505, upstream traffic specification information associated with a plurality of spoke nodes is received. An UPSTREAM_TSPEC, as defined in RFC 6387 in the Resv message, is received from each spoke, e.g., either directly or through an upstream LSR.

At block 510, the upstream traffic specification information is sent to a hub. In one embodiment, using the P-method, the intermediate LSRs combine UPSTREAM_TSPECs received from the upstream LSRs using the Sum Tspec operation referred to in RFC2205. In this case, the Sum Tspec operation is a calculation of the sum of all Tspecs supplied by spokes directly or indirectly coupled to the intermediate LSR. Note that the LSR maintains state within each Resv State Block (RSB) about the Tspec sent by the upstream LSR.

In one embodiment, using the G-method, the intermediate LSR does not combine the Tspecs, but rather propagates the information about the Tspec requested by each spoke, e.g., spoke node or leaf node, all the way to the hub. This information can be conveyed by modifying the packet formats already defined in RFC 4875 and RFC 6387. There are several ways to modify the packet format. In one embodiment, instead of the UPSTREAM_TSPEC defined in RFC6387, a new modified object UPSTREAM_TSPEC_list is used and is defined as follows. Its encoding is:

UPSTREAM_TSPEC_list::==UPSTREAM_TSPEC
UPSTREAM_SENDER_TEMPLATE [ UPSTREAM_TSPEC_list ]

The UPSTREAM_SENDER_TEMPLATE is similar to the SENDER_TEMPLATE that is defined in RFC 3209. However, in this case, the IP address in the UPSTREAM_SENDER_TEMPLATE is the address of the respective spoke.

At block 515, upstream flow specification information is received from the hub. When the P-method is used, an upstream flow specification is received, e.g., in a path message from the hub. When the G-method is used, the intermediate LSR receives a flow specification, e.g., a S2L_SUB_LSP_FLOWSPEC object.

At block 520, the upstream flow specification information is used to allocate resources among the plurality of spoke nodes either proportionally or in accordance with a resource sharing mode.

When the P-method is used, each intermediate LSR generates an upstream flow specification to be sent to the upstream LSR or directly coupled spoke using the “proportional flowspec” operation. In one embodiment, the intermediate LSR generates an UPSTREAM_FLOWSPEC in proportion to the Tspec received from the upstream LSRs and directly coupled spokes.

When the G-method is used, an intermediate LSR processes the object as it would process a normal FLOWSPEC object except that it now takes into account the resource sharing mode (i.e. fixed filter (FF), shared explicit (SE)) and allocates resources accordingly.

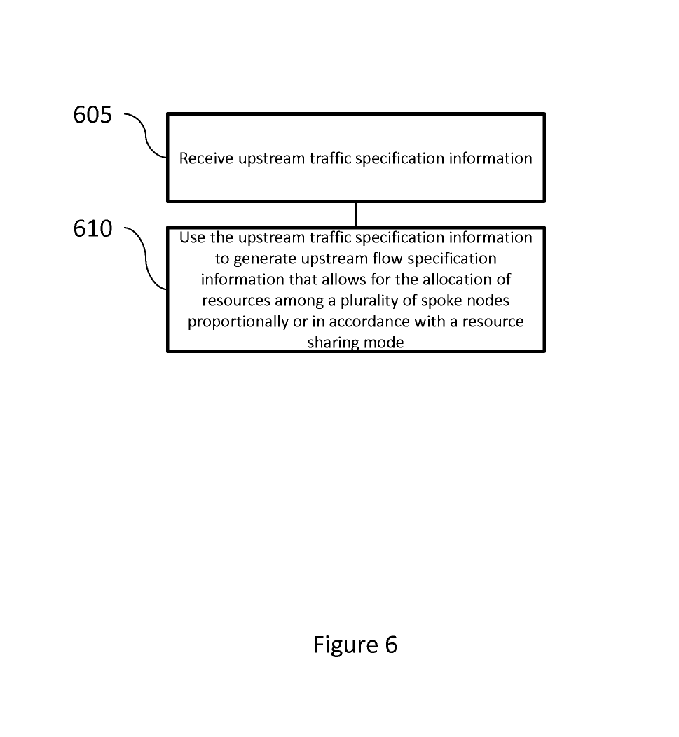

FIG. 6 illustrates a block diagram of a method for enabling efficient resource allocation for point to multi-point signaling using a hub according to one embodiment. At block 605, upstream traffic specification information is received.

In one embodiment, the upstream traffic specification information is received using the P-method. In the P-method, a combination of the upstream traffic specifications (UPSTREAM_TSPECS) of the respective spokes is received by the hub from the intermediate LSR. The UPSTREAM_TSPECs are combined by the intermediate LSR using the Sum Tspec operation referred to in RFC2205. In this case, the Sum Tspec operation is a calculation of the sum of all Tspecs supplied by spokes directly or indirectly coupled to the intermediate LSR.

In one embodiment, using the G-method, the upstream traffic specification information is an upstream traffic specification list. The information about the Tspec requested by each spoke, e.g., spoke node or leaf node, is propagated all the way to the hub.

At block 610, the upstream traffic specification information is used to generate an upstream flow specification information that allows for the allocation of resources among a plurality of spoke nodes. This allocation of resources can be made proportionally or in accordance with a resource sharing mode.

In one embodiment, the P-method is used. In this embodiment, the upstream traffic specification information is used to generate upstream flow specification information (UPSTREAM_FLOWSPEC). The hub generates an UPSTREAM_FLOWSPEC to be sent in a Path message.

In one embodiment, the G-method is used. When the hub processes the UPSTREAM_TSPEC_list, the hub generates an appropriate UPSTREAM_FLOWSPEC for that S2L sub-LSP, e.g., the path from the hub to a respective spoke node or leaf node, and signals the S2L sub-LSP, e.g., using one or more Path messages. As described in RFC 4875, one or more path messages can be used to signal one or more S2L sub-LSPs. To signal an UPSTREAM_FLOWSPEC per S2L sub LSP, there are several ways to encode the information. In one embodiment, the format of the S2L_SUB_LSP is modified by appending an S2L_SUB_LSP_FLOWSPEC object to it. The format of the S2L_SUB_LSP_FLOWSPEC is the same as the FLOWSPEC object defined in RFC 2205.

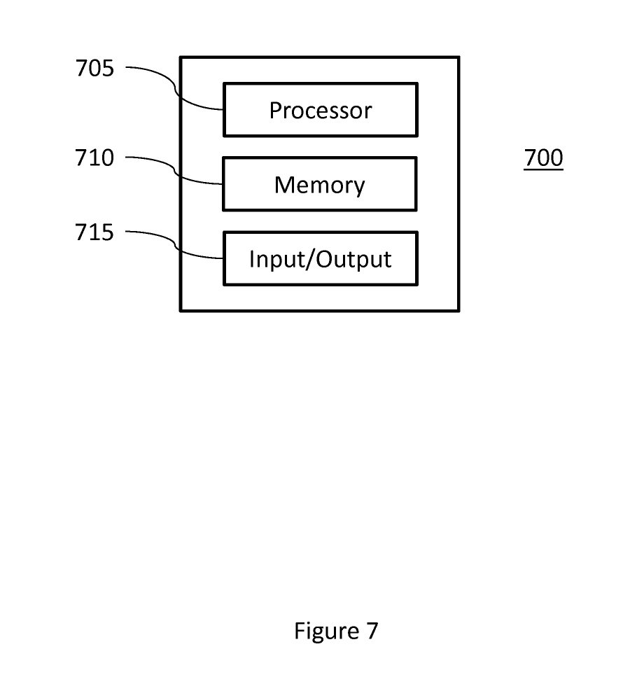

FIG. 7 illustrates an example network node or element, e.g., a spoke, an intermediate node, an upstream node, and/or a hub. Network node 700 comprises a processor (CPU) 705, a memory 710, e.g., random access memory (RAM) and/or read only memory (ROM), and various input/output devices 715, (e.g., storage devices, including but not limited to, a tape drive, a floppy drive, a hard disk drive or a compact disk drive, a receiver, a transmitter). Network node 700 is capable of enabling efficient resource allocation for point to multi-point signaling.

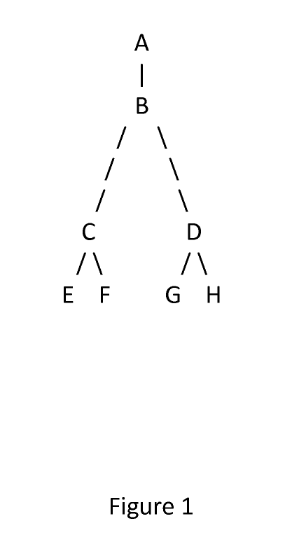

The processes described above, including but not limited to those presented in connection with FIGS. 1-7, may be implemented in general, multi-purpose or single purpose processors. Such a processor, e.g., processor 705, will execute instructions, either at the assembly, compiled or machine-level, to perform that process. Those instructions can be written by one of ordinary skill in the art following the description of presented above and stored or transmitted on a computer readable medium, e.g., a non-transitory computer-readable medium. The instructions may also be created using source code or any other known computer-aided design tool. A computer readable medium may be any medium capable of carrying those instructions and include a CD-ROM, DVD, magnetic or other optical disc, tape, silicon memory (e.g., removable, non-removable, volatile or non-volatile), packetized or non-packetized wireline or wireless transmission signals.

While the invention has been described in terms of several embodiments, those skilled in the art will recognize that the invention is not limited to the embodiments described. The description is thus to be regarded as illustrative instead of limiting.

What is claimed is:

1. A method for enabling efficient resource allocation for point to multi-point signaling using an intermediate label switched router (LSR), which comprises:
receiving upstream traffic specification information associated with a plurality of spoke nodes;
sending the upstream traffic specification information to a hub;
receiving upstream flow specification information from the hub; and
using the upstream flow specification information to allocate resources among the plurality of spoke nodes proportionally or in accordance with a resource sharing mode.

2. The method of claim 1, wherein the upstream traffic specification information is combined from the plurality of spoke nodes.

3. The method of claim 2, wherein combining upstream traffic specification information comprises determining a sum of upstream traffic specifications from the plurality of spoke nodes.

4. The method of claim 2, wherein the upstream flow specification information is received in a path message from the hub.

5. The method of claim 4, wherein the intermediate LSR generates an upstream flow specification using a proportional flow specification operation.

6. The method of claim 5, wherein the generated upstream flow specification is calculated as a fraction of the received upstream flow specification.

7. The method of claim 1, wherein the traffic specification information for each spoke node is propagated to the hub.

8. The method of claim 7, wherein the traffic specification information for each node is propagated to the hub using an upstream traffic specification list generated by the intermediate LSR.

9. The method of claim 8, wherein the upstream traffic specification list is sent to the hub using an upstream sender template.

10. A method for enabling efficient resource allocation for point to multi-point signaling using a hub, which comprises:
receiving upstream traffic specification information from an intermediate label switch router, the upstream traffic specification information comprising an upstream traffic specification list; and
using the upstream traffic specification list to generate an upstream flow specification for each respective sub label switch path (sub-LSP).

11. The method of claim 10, wherein a format of the sub-LSP is modified by appending a sub-LSP flow specification.

12. An intermediate label switched router (LSR) for enabling efficient resource allocation for point to multi-point signaling, comprising:
a processor configured to:
receive upstream traffic specification information associated with a plurality of spoke nodes;
send the upstream traffic specification information to a hub;
receive upstream flow specification information from the hub; and
use the upstream flow specification information to allocate resources among the plurality of spoke nodes proportionally or in accordance with a resource sharing mode.

13. The intermediate LSR of claim 12, wherein the upstream traffic specification information is combined from the plurality of spoke nodes.

14. The intermediate LSR of claim 13, wherein combining upstream traffic specification information comprises determining a sum of upstream traffic specifications from the plurality of spoke nodes.

15. The intermediate LSR of claim 13, wherein the upstream flow specification information is received in a path message from the hub.

16. The intermediate LSR of claim 15, wherein the intermediate LSR generates an upstream flow specification using a proportional flow specification operation.

17. The intermediate LSR of claim 12, wherein the traffic specification information for each spoke node is propagated to the hub.

18. The intermediate LSR of claim 17, wherein the traffic specification information for each node is propagated to the hub using an upstream traffic specification list generated by the intermediate LSR.

19. The intermediate LSR of claim 18, wherein the upstream traffic specification list is sent to the hub using an upstream sender template.

20. A hub for enabling efficient resource allocation for point to multi-point signaling, comprising:
a processor configured to:
receive upstream traffic specification information from an intermediate label switch router, the upstream traffic specification information comprising an upstream traffic specification list; and
use the upstream traffic specification list to generate an upstream flow specification for each respective sub label switch path (sub-LSP).
